(19) United States
(12) Patent Application Publication
(10) Pub. No.: US 2023/0046106 A1
(43) Pub. Date: Feb. 16, 2023

(54) LAMP

(71) Applicant: Hangzhou Hangke Optoelectronics Co., Ltd., Hangzhou (CN)

(72) Inventors: Qianjun YAN, Hangzhou (CN); Zhaozhang ZHENG, Hangzhou (CN); Lingli MA, Hangzhou (CN)

(73) Assignee: Hangzhou Hangke Optoelectronics Co., Ltd., Hangzhou, ZJ (CN)

(21) Appl. No.: 17/644,954

(22) Filed: Dec. 17, 2021

(30) Foreign Application Priority Data
Aug. 13, 2021 (CN) 202121904712.8
Sep. 23, 2021 (CN) 202122303085.9

(51) Int. Cl. F21K 9/232; F21K 9/69

(52) U.S. Cl. CPC F21K 9/232; F21K 9/69

(57) ABSTRACT

A lamp provided includes a lamp base, a light-transmitting housing, a light-emitting component, a lens and a bracket. The bracket fixes the light-emitting component, the light-emitting component is arranged towards a light incident surface of the lens; and the light incident surface of the lens is arranged in parallel to or at an angle with the light-emitting component. The housing includes a convex part opposite to the lamp base, and the lens is arranged on the inner surface of the convex part. A bulb lamp with condensing effect is provided.

### CROSS-REFERENCE TO RELATED APPLICATIONS

This Non-provisional application claims priority under 35 U.S.C. § 119(a) to Chinese Patent Application No. 202121904712.8, filed on Aug. 13, 2021, and to Chinese Patent Application No. 202122303085.9, filed on Sep. 23, 2021, the entire contents of each of which are hereby incorporated by reference in their entirety.

### TECHNICAL FIELD

The disclosure relates to a field of lamp lighting.

### BACKGROUND ART

A traditional bulb lamp does not present condensing effect. FIG. 11 shows a light distribution curve of the traditional bulb. An illumination angle of a filament lamp or bulb lamp is very large, and a condensing function cannot be realized.

### SUMMARY

In view of shortcomings in the prior art, the disclosure provides a bulb lamp with a light condensing function.

In order to solve the above technical problems, the present disclosure provides following technical solutions.

A lamp includes a lamp base, a light-transmitting housing, a light-emitting component, a lens and a bracket. The bracket fixes the light-emitting component, the light-emitting component is arranged towards a light incident surface of the lens; and the light incident surface of the lens is arranged in parallel to or at an angle with the light-emitting component.

Optionally, a light-emitting surface of the light-emitting component is arranged towards the light incident surface of the lens, and the light incident surface of the lens is arranged in parallel or at an angle with the light-emitting surface.

Optionally, the light-emitting surface is a surface where a LED chip or LED lamp bead is located.

Optionally, the light-emitting component is at an angle of 0-60° with the light incident surface of the lens.

Optionally, a thickness of the lens is less than or equal to 100 mm, and a distance between the light-emitting component and the lens is less than or equal to 200 mm.

Optionally, the light-transmitting housing includes a convex part farthest from the lamp base, and the lens is arranged on an inner surface of the convex part.

Optionally, the lens on the light-transmitting housing includes a first lens and a second lens, and the second lens is between the first lens and the light-emitting component.

Optionally, the second lens includes a light incident surface and a light emission surface which are parallel to each other, and a light incident surface of the first lens is parallel to the second lens.

Optionally, the light-emitting component includes a COB lamp panel which includes a light-emitting surface opposite to the light incident surface of the lens, and the light-emitting surface of the COB lamp panel faces the light incident surface of the lens.

Optionally, the light-emitting component includes a lamp panel made of SMD. The lamp panel includes at least one LED luminescent particle, and the light-emitting surface of the lamp panel made of SMD faces the light incident surface of the lens.

Optionally, the light-emitting component includes at least one group of LED filaments, and the light-emitting surfaces of the LED filaments are arranged towards the light incident surface of the lens.

Optionally, the light-emitting component has a three-dimensional structure.

Optionally, the light-emitting component is a spiral light-emitting component, and a light-emitting surface of the spiral light-emitting component is arranged towards the light incident surface of the lens.

Optionally, the light-emitting component is an arc-shaped lamp panel, and the light-emitting surface is an arc-shaped surface where the LED chip or the LED lamp bead is located.

Optionally, the lens is of a cured light-transmitting colloid.

Optionally, a stem is further included, and the bracket is fixed on the stem.

Optionally, the light-emitting component includes a red light source.

Optionally, a part of the light-transmitting housing other than the lens is provided with a coating.

Optionally, the light-emitting component includes a third lens, and the third lens is fixed on the light-emitting component.

Optionally, the light-emitting component is located inside the lens.

The disclosure provides following beneficial effects.

1) a condensing function of the bulb lamp is realized in this disclosure;

2) in technical schemes of the disclosure, a light emitting angle can be adjusted by adjusting a distance between the light-emitting component and the lens:

3) an adjustment of various condensing effects which cannot be realized by a traditional spotlight can be realized with a structure of the disclosure.

### BRIEF DESCRIPTION OF THE DRAWINGS

In order to explain the embodiments of the present disclosure or the technical scheme in the prior art more clearly, the drawings required in the description of the embodiments or the prior art will be briefly introduced below; obviously, the drawings in the following description are only some embodiments of the present disclosure, and other drawings can be obtained according to these drawings by those of ordinary skill in the art without paying creative labor.

FIG. 1 is a structural diagram of a lamp disclosed in Embodiment 1;

FIG. 2 is a structural diagram of a lamp disclosed in Embodiment 2;

FIG. 3 is a structural diagram of a lamp disclosed in Embodiment 3;

FIG. 4 is a structural diagram of a lamp disclosed in Embodiment 4;

FIG. 5 is a structural diagram of a lamp disclosed in Embodiment 5;

FIG. 6 is a structural diagram of a lamp disclosed in Embodiment 6;

FIG. 7 is a structural diagram of a lamp disclosed in Embodiment 7;

FIG. 8 is a structural diagram of a lamp disclosed in Embodiment 8;

FIG. 9 is a structural diagram of a lamp disclosed in Embodiment 9;

FIG. 10 is a structural diagram of a lamp disclosed in Embodiment 10;

FIG. 11 is a light distribution curve of a prior art bulb lamp;

FIG. 12 is a light distribution curve of the lamp described in Embodiment 12;

FIG. 13 is another light distribution curve of the lamp described in Embodiment 12; and

FIG. 14 is another light distribution curve of the lamp described in Embodiment 12.

### DETAILED DESCRIPTION

The present disclosure will be further described in detail with reference to the following examples which present explanation the present disclosure and the present disclosure is not limited to the following examples.

### Embodiment 1

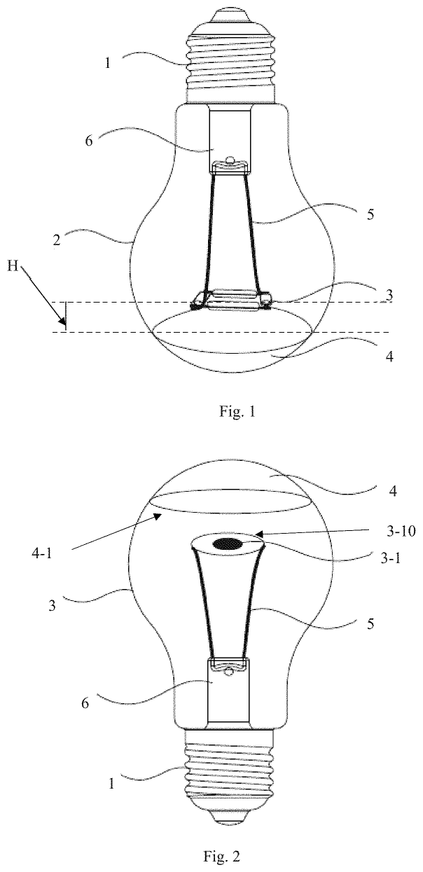

As shown in FIG. 1, a lamp includes a lamp base 1, a light-transmitting housing 2 (hereinafter referred to as a bulb), a light-emitting component 3, a lens 4 and a bracket 5. The bracket fixes the light-emitting component, the light-emitting component is arranged towards a light incident surface of the lens; and the light incident surface of the lens is arranged in parallel to or at an angle with a light-emitting surface of the light-emitting component. Generally, it can be understood that the light-emitting surface of the light-emitting component is arranged towards the light incident surface of the lens. Further, the light-emitting component may have a plurality of light-emitting surfaces, and at least one of the light-emitting surfaces is parallel to the light incident surface of the lens. It is conceivable that at least half of the light-emitting surfaces may be parallel to the light incident surface of the lens.

The lens is located inside the bulb, and the light incident surface of the lens is opposite to an emission direction of a light source of the light-emitting component. The housing includes a convex part opposite to the lamp base, and the lens is arranged on the inner surface of the convex part.

As shown in FIG. 1, the light-emitting component includes at least one group of LED filaments, and a LED filament includes more than one luminescent particle and at least two sections of conductive components. The luminescent particles can be LED chips or LED lamp beads. The LED filament is parallel to the light incident surface of the lens.

Specifically, the lamp also includes a stem 6 on which the bracket is mounted, an end of the bracket is connected with four filaments, and the filaments are mounted parallel to the light incident surface of the lens.

Here, the filament has various forms. In a first form, LED chips on the filament are all located on one side of the filament, that is, on the light-emitting surface, so that the light-emitting surface faces the light incident surface of the lens.

In a second form, the LED chip on the filament is mounted on both sides of the filament, as long as one of the both sides faces the light incident surface of the lens.

In a third form, in other embodiments, if the filament emits light on multiple sides, a position of the light-emitting surface is not considered, and the filament can be directly and parallelly mounted on the light incident surface of the lens.

The luminescent particles can be LED chips directly fixed on a strip-shaped substrate or LED lamp beads fixed on the strip-shaped substrate. The LED lamp bead in this case can be understood as including a granular substrate, an LED chip fixed on the granular substrate, a light-transmitting plastic layer or a colloidal layer covering the chip, and a light source with an exposed conductive end.

In other conceivable embodiments, the filament may adopt a filament-like structure or a strip-like structure composed of an LED chip structure without a substrate and a conductive component.

A thickness of the lens is less than or equal to 100 mm, and a distance between the light-emitting component and the lens is less than or equal to 200 mm.

A design of this structure depends on a size of the bulb lamp commonly used at present. Generally, a distance between the lamp base and a top of the bulb is 30 mm-300 mm in different models, and there are also bulbs with a distance not within this distance range. Taking A60 bulb lamp as an example, in Embodiment 12, the condensing effect of the lamp with a bracket length of 30 mm, 25 mm or 20 mm are further described respectively.

Further, the lens is of a cured light-transmitting colloid, and other light-transmitting plastics can also be used.

In other embodiments, other lens structures may be mounted to the light-transmitting housing, externally or internally.

In this embodiment, colloid is used to fill the bulb lamp, and in other embodiments, a practical finished lens is mounted on the light-transmitting housing.

### Embodiment 2

As shown in FIG. 2, a lamp includes a lamp base 1, a light-transmitting housing 2 (hereinafter referred to as a bulb), a light-emitting component 3, a lens 4 and a bracket 5. The bracket fixes the light-emitting component, a light-emitting surface of the light-emitting component is arranged towards a light incident surface 4-1 of the lens; and the light incident surface of the lens is arranged in parallel to or at an angle with the light-emitting surface of the light-emitting component.

Further, the light-emitting component may have a plurality of light-emitting surfaces, and at least one of the light-emitting surfaces is parallel to the light incident surface of the lens. It is conceivable that at least half of the light-emitting surfaces may be parallel to the light incident surface of the lens.

The lens is located inside the bulb, and the light incident surface of the lens is opposite to an emission direction of a light source of the light-emitting component. That is, the light-emitting surface is arranged towards the light incident surface. The housing includes a convex part opposite to the lamp base, and the lens is arranged on the inner surface of the convex part.

This embodiment is different from Embodiment 1 in that the light-emitting component of Embodiment 1 is with a filament, and a light-emitting component of Embodiment 2 includes a COB panel 3-1 which includes a light-emitting surface 3-10 and a backlight surface. The light-emitting surface is opposite to the light incident surface of the lens, that is, the light-emitting surface faces the light incident surface of the lens, while the COB panel is parallel to the light incident surface of the lens.

In other conceivable embodiments, the COB lamp panel may have an oblique angle with the light incident surface of the lens, and the angle may be 0-60°, providing different light effects. If the angle is greater than 60°, less direct light enters the lens, and its condensing effect is not ideal, but this configuration is not excluded.

### Embodiment 3

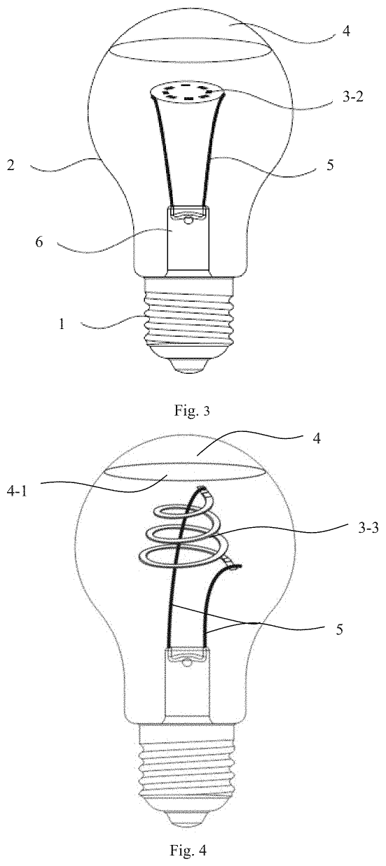

As shown in FIG. 3, a lamp includes a lamp base 1, a light-transmitting housing 2, a light-emitting component 3, a lens 4 and a bracket 5. The bracket fixes the light-emitting component, a light-emitting surface of the light-emitting component is arranged towards a light incident surface of the lens; and the light incident surface of the lens is arranged in parallel to or at an angle with the light-emitting surface of the light-emitting component.

Further, the light-emitting component may have a plurality of light-emitting surfaces, and at least one of the light-emitting surfaces is parallel to the light incident surface of the lens. It is conceivable that at least half of the light-emitting surfaces may be parallel to the light incident surface of the lens.

The lens is located inside the bulb, and the light incident surface of the lens is opposite to an emission direction of a light source of the light-emitting component. The housing includes a convex part opposite to the lamp base, and the lens is arranged on the inner surface of the convex part.

This embodiment is different from Embodiment 1 in that the light-emitting component of Embodiment 1 is with a filament, and a light-emitting component of Embodiment 3 includes a lamp panel 3-2 made of SMD, which includes at least one LED lamp bead, and the lamp panel made of SMD is parallel to the light incident surface of the lens. The LED lamp bead of this embodiment refers to the lamp bead structure described in Embodiment 1.

### Embodiment 4

A main difference between this embodiment and Embodiment 1 is that the light-emitting component in Embodiment 1 includes four groups of filaments, and this embodiment adopts one filament which has a spiral structure. The whole filament of the spiral structure is suspended and fixed, and two brackets 5 are provided on the stem, one of which is connected to one end of the filament of the spiral structure, and the other of which is connected to the other end of the filament of the spiral structure, thus realizing suspending fixation and electrical connection of the filament. In this embodiment, a base of the filament with the spiral structure is required to adopt a substrate with plastic performance, such as a rigid substrate like an aluminum substrate. After the spiral structure is formed, the filament can be shaped so as not to be moved or shaken. Thus, a stable light source is formed.

A side of the filament of the spiral structure opposite to the light incident face 4-1 of the lens is a light-emitting surface, that is, a side of the filament of the spiral structure provided with LED chips or LED beads is the light-emitting surface, which is arranged toward the light incident face of the lens. It can be seen that the light-emitting surface is not parallel to the light incident surface of the lens, but follows the spiral structure, and an angle between the light-emitting surface and the light incident surface is a continuously changing angle.

In other conceivable embodiments, the filament can be a three-dimensional structure such as a curved or bending structure and the like, and is not limited to the spiral structure. The substrate of the filament can also be a flexible substrate, such as FPC, which is not limited to the rigid substrate, and a fixture can be used to fix the filament in the bulb.

### Embodiment 5

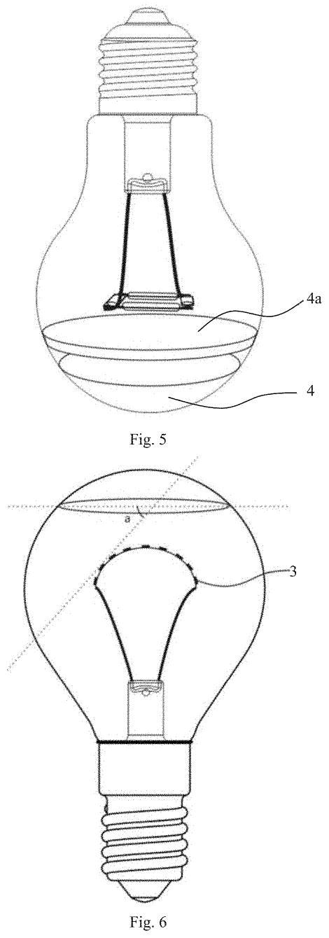

A bulb lamp, as shown in FIG. 5, includes two lenses, namely a first lens 4 and a second lens 4a. The first lens includes an arc surface and a light incident surface, the arc surface is closely contact with the light-transmitting housing, and a second lens is arranged above the first lens.

The second lens includes a light incident surface and a light emission surface which are parallel to each other, and a light incident surface of the first lens is parallel to the second lens. The light source of this embodiment which emits from two groups of lenses has better condensing effect.

The light-emitting component can be any one of Embodiment 1, Embodiment 2, Embodiment 3 or Embodiment 4, and other conceivable light-emitting components with a light-emitting surface being arranged towards the light incident surface of the lens can also be used.

### Embodiment 6

A bulb lamp is disclosed in this embodiment, as shown in FIG. 6, its light-emitting component is an arc-shaped light-emitting component, and a light-emitting surface of the arc-shaped light-emitting component is arc-shaped, that is, the substrate is an arc-shaped substrate and the arc-shaped substrate is provided with a plurality of LED chips or LED lamp beads connected in series or in parallel or in a mixed series-parallel manner. That is, the flexible filament of Embodiment 1, the COB lamp panel of Embodiment 2 or the SMD lamp panel of Embodiment 3 can be used.

In this embodiment, a convex side of the arc-shaped substrate is provided with a plurality of LED chips or LED lamp beads in series or in parallel or in a mixed series-parallel manner. That is, the convex surface is a light-emitting surface, and the light-emitting surface is mounted toward the light incident surface of the lens.

An angle α is an angle between the light incident surface and the light-emitting surface. It can be considered that the arc-shaped light-emitting surface has a plurality of continuous light-emitting surfaces, each including at least one LED chip or LED lamp bead. Angles between a plurality of continuous light-emitting surfaces and the light incident surface are between 0 and 60°.

In other conceivable embodiments, a concave surface of the arc-shaped substrate has a plurality of LED chips or LED lamp beads in series or in parallel or in a mixed series-parallel manner, that is, the concave surface is a light-emitting surface, and the concave light-emitting surface is mounted toward the light incident surface of the lens.

### Embodiment 7

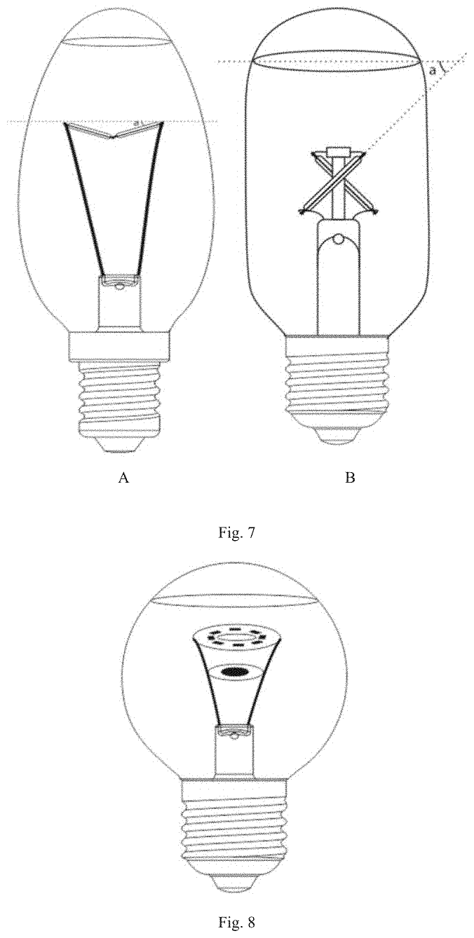

A bulb lamp is disclosed in this embodiment, as shown in FIG. 7, its light-emitting component includes two straight-rod filaments widths of which can be adjusted, and it can also be regarded as a lamp strip. The two filaments or the lamp strip are connected to form a V-shape, an inverted V-shape or an X-shape. If the lamp base faces upwards, it can be considered that in FIG. 7, a shape in figure A is the V-shape, and a shape in figure B is the inverted V-shape or X-shape.

With regard to the light-emitting component of this embodiment, it can be composed of one filament, two filaments or more, and a light-emitting surface of each filament is arranged toward the light incident surface of the lens. Angles α between these filaments and the light incident surface is 0-60°. Different angles lead to different light effects, and each filament can have a same angle or a different angle, which can be configured according to different needs.

Difference is that the filament is arranged parallel to the light incident surface in FIG. 1 in Embodiment 1, while the filament is arranged at an angle in this embodiment. Of course, the bulb lamp can be selected with both parallel filaments and angled filaments.

### Embodiment 8

A bulb lamp is disclosed in this embodiment, as shown in FIG. 8. Its light-emitting component is composed of a COB lamp panel and an SMD lamp panel which are arranged vertically. Both of the lamp panels are arranged towards the light incident surface of the lens, and both of the lamp panels are parallel to the light incident surface. And description of Embodiment 2 and Embodiment 3 can be referred for a specific structure of the two lamp panels. A combined structure is disclosed in this embodiment.

Specifically, one of the lamp panels proximate to the lens is a circular lamp panel with a hollow middle part, and a light-emitting surface of the other lamp panel is just at a opposite position to the hollow part, that is, a light source of the other lamp panel just emits from the hollow part.

In other embodiments, one of the two lamp panels away from the lens may be a hollow annular lamp panel, and the lamp panel proximate to the lens matches a hollow shape of the annular lamp panel; or, a light source away from the lens may be a filament.

### Embodiment 9

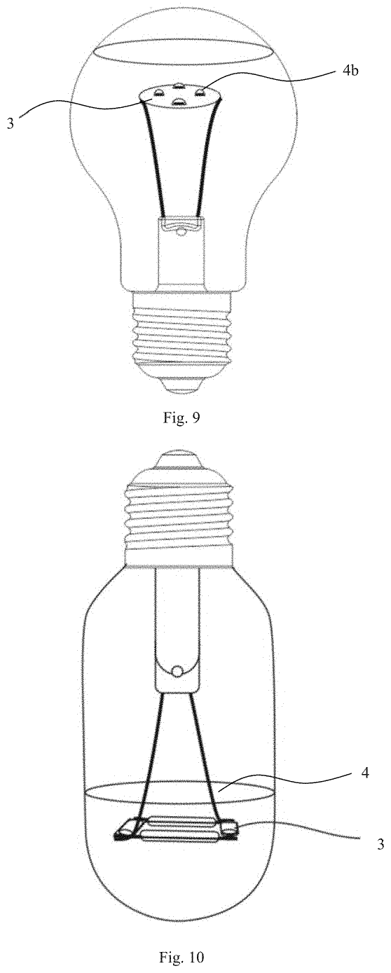

A bulb lamp is disclosed in this embodiment, as shown in FIG. 9, the light-emitting component 3 of the bulb lamp comprises a third lens 4b, and the third lens is fixed on the light-emitting component. Specifically, the light-emitting component includes a plurality of LED beads fixed on a substrate, and a surface of each LED bead is provided with a third lens 4b matched with a size of the LED bead. Light emitted by the LED lamp bead can be condensed by the third lens on the surface of the LED lamp bead firstly, and then emitted to the lens on the bulb. In this way, light condensing effect of the bulb lamp disclosed in this embodiment is better.

In another conceivable embodiment, the third lens is provided on the substrate, and the third lens covers the plurality of LED lamp beads.

Further, the LED lamp beads in this embodiment can be replaced by LED chips, and the LED chips in this paper refer to LED bare chips.

Further, the light-emitting component in this embodiment can be the flexible filament in Embodiment 1 or the COB lamp panel in Embodiment 2.

Difference between this embodiment and other embodiment lies in the structure of the light-emitting component, and structures of other parts of the bulb lamp can be known from Embodiment 1.

### Embodiment 10

A bulb lamp is disclosed in this embodiment. As shown in FIG. 10, the light-emitting component 3 is inside the lens 4. Other parts are the same as those in Embodiment 1. This structure and concept can also be applied to the schemes disclosed in Embodiments 2 to 9.

### Embodiment 11

A lamp preparation process for preparing the bulb lamps disclosed in Embodiments 1 to 10 is disclosed. The bulb lamp includes a lamp base, a light-transmitting housing, a light-emitting component, a lens, and a bracket. The bracket fixes the light-emitting component, the light-emitting component is arranged towards a light incident surface of the lens; and the light incident surface of the lens is arranged in parallel to or at an angle with a light-emitting surface of the light-emitting component.

Specifically, the process includes a method of disposing a lens in a housing of the lamp. The method includes following steps: filling fluidic light-transmitting colloid (glue) into the light-transmitting housing and curing the fluidic light-transmitting colloid (glue) into solid;

fixing the light-emitting component on the bracket; and sealing the bracket fixed with the light-emitting component and the light-transmitting housing.

An electrical lead-out wire on the bracket is electrically connected with the lamp base. If there is a power supply component, the electrical lead-out wire is firstly electrically connected with the power supply component and then electrically connected with the lamp base through the power supply component.

The method specifically includes following steps 1 to 5:

Step 1: filling colloid into the bulb, in which mass or volume of the colloid is prepared according to a preset lens thickness;

Step 2: vacuumizing the bulb after the bulb is filled with the colloid, and standing for the colloid to solidify;

Step 3: spot welding to fix the light-emitting component on the bracket:

Step 4: sealing the bulb, namely sealing the bracket with the light source fixed with the bulb;

Step 5: performing an assemble to electrically connect the power supply component with the electric lead-out wire on the bracket and electrically connect the power supply component with the lamp base if there is a power supply component; or to connect the electrical lead-out wire on the bracket directly with the lamp base if there is no power supply component.

### Embodiment 12

A method for adjusting a light emitting angle of a bulb lamp, for adjusting the light emitting angle of the lamps described in Embodiments 1 to 10 and adjusting a position of a light-emitting component inside the bulb lamp, which specifically includes adjusting a distance between the light-emitting component and a lens. In the lamp of this embodiment, an illumination angle of light emitted by the light-emitting component after passing through the lens, that is a average beam angle (50%), is less than 120 degrees.

As shown in FIG. 1, a height H is adjusted. In production, the height H is mainly adjusted by adjusting a length of the bracket.

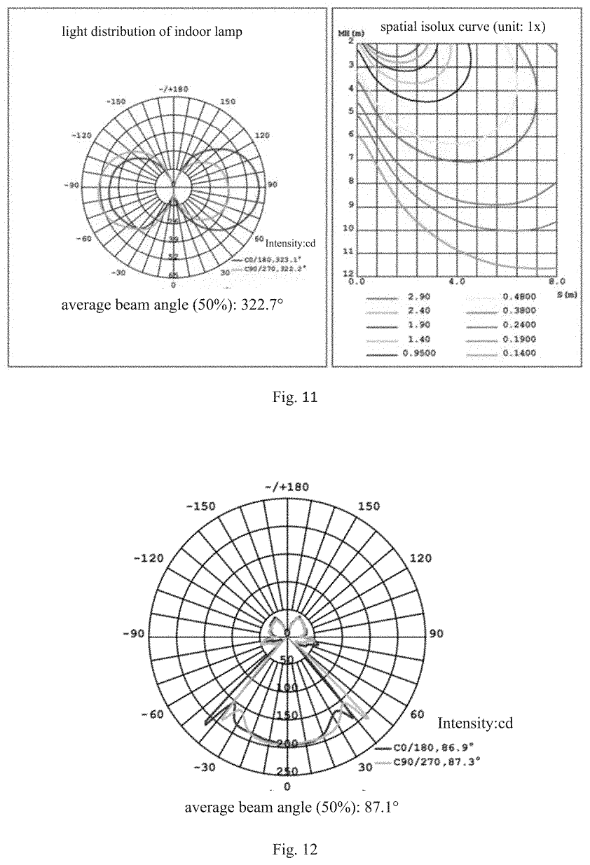

Taking the A60 bulb lamp and the light-emitting component disclosed in Embodiment 1 as an example, light distribution curves are shown in FIG. 12 to FIG. 14.

C indicates an angle of the horizontal plane:

C0/180 indicates light distribution on a section constituted by 0° to 180° (a plane constituted by 0° and 180°);

C90/270 indicates light distribution on a section constituted by 90° to 270°;

When light distributions in C0 and C180° sections of the lamp is symmetrical, and light distributions in C90° and C270° sections is symmetrical, such a light distribution curve is called symmetrical light distribution.

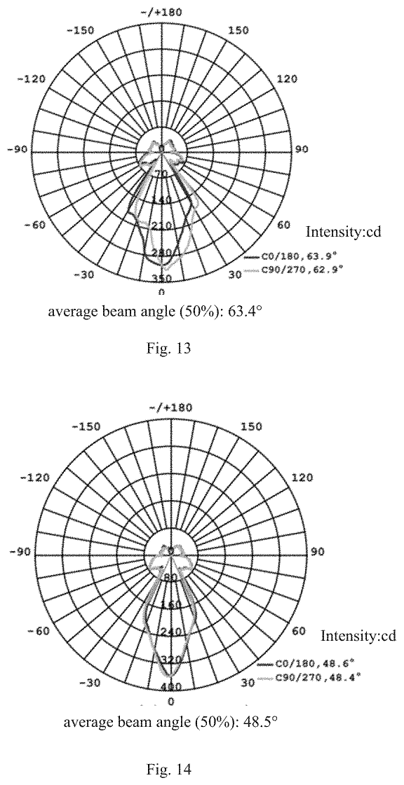

FIG. 12 to FIG. 14 shows light distribution curves of the bulb lamp with metal bracket lengths of 30 mm (FIG. 12), 25 mm (FIG. 13) and 20 mm (FIG. 14), respectively. Therefore, it can be known that if a lens and a light-emitting component are provided in a bulb or the like, the shorter the bracket of the light-emitting component is and the farther it is from the lens, the smaller the light emitting angle is, and the more condensed the light is.

Further, referring to the light distribution curve in FIG. 12 which is a fan-like shape, two sides of the fan are recessed to form two wings.

Further, with the light-emitting components disclosed in Embodiments 1-10, different condensing effects can be realized after emitted light passes through the lens. On this basis, there are various possibilities in aesthetic design and condensing effect design of the bulb lamp.

Further, for its application field, the bulb lamp can be applied to the agricultural field, in which a light source of the light-emitting component is a red light source, which serves as a plant growth lamp, and due to the light condensing effect of the bulb lamp in this technical scheme, it is very suitable for crop growth.

In addition, the above-mentioned light-emitting surface is a surface on which the LED chips or LED beads of the light-emitting component are arranged, and can also be a side of the light-emitting component with a maximum light intensity.

In addition, it should be noted that the specific embodiments described in this specification may have different shapes, names or the like of parts and components. Equivalent or simple changes made in accordance with the configurations, features and principles described in the inventive concept are included in the scope of protection of the inventive disclosure. Various modifications, supplements or similar replacements can be made to the described specific embodiments by those skilled in the art to which the present disclosure pertains, which fall within the protection scope of the present disclosure without departing from the structure or concept of the present disclosure.

1. A lamp, comprising a lamp base, a light-transmitting housing, a light-emitting component, a lens and a bracket, wherein the bracket fixes the light-emitting component, the light-emitting component is arranged towards a light incident surface of the lens; and
the light incident surface of the lens is arranged in parallel to or at an angle with the light-emitting component;
wherein the light-transmitting housing comprises a convex part farthest from the lamp base, the lens is arranged on an inner surface of the convex part, the lens has an arc surface, and the arc surface is contacted with the convex part of the light-transmitting housing.

2. The lamp according to claim 1, wherein a light-emitting surface of the light-emitting component is arranged towards the light incident surface of the lens, and the light incident surface of the lens is arranged in parallel or at an angle with the light-emitting surface.

3. The lamp according to claim 2, wherein the light-emitting surface is a surface where a LED chip or LED lamp bead is located.

4. The lamp according to claim 1, wherein the light-emitting component is at an angle of 0-60° with the light incident surface of the lens.

5. The lamp according to claim 1, wherein a thickness of the lens is less than or equal to 100 mm, and a distance between the light-emitting component and the lens is less than or equal to 200 mm.

6. (canceled)

7. The lamp according to claim 1, wherein the lens on the light-transmitting housing comprises a first lens and a second lens, and the second lens is between the first lens and the light-emitting component.

8. The lamp according to claim 7, wherein the second lens comprises a light incident surface and a light emission surface which are parallel to each other, and a light incident surface of the first lens is parallel to the second lens.

9. The lamp according to claim 3, wherein the light-emitting component comprises a COB lamp panel, the COB lamp panel comprises a light-emitting surface opposite to the light incident surface of the lens, and the light-emitting surface of the COB lamp panel faces the light incident surface of the lens.

10. The lamp according to claim 3, wherein the light-emitting component comprises a lamp panel made of SMD, the lamp panel comprises at least one LED luminescent particle, and the light-emitting surface of the lamp panel made of SMD faces the light incident surface of the lens.

11. The lamp according to claim 3, wherein the light-emitting component comprises at least one group of LED filaments, and the light-emitting surfaces of the LED filaments are arranged towards the light incident surface of the lens.

12. The lamp according to claim 11, wherein the light-emitting component is of a three-dimensional structure.

13. The lamp according to claim 12, wherein the light-emitting component is a spiral light-emitting component, and a light-emitting surface of the spiral light-emitting component is arranged towards the light incident surface of the lens.

14. The lamp according to claim 9, wherein the light-emitting component is an arc-shaped lamp panel, and the light-emitting surface is an arc-shaped surface where the LED chip or the LED lamp bead is located.

15. The lamp according to claim 11, wherein the lens is of a cured light-transmitting colloid.

16. The lamp according to claim 11, further comprising a stem, the bracket being fixed on the stem.

17. The lamp according to claim 11, wherein the light-emitting component comprises a red light source.

18. The lamp according to claim 11, wherein a part of the light-transmitting housing other than the lens is provided with a coating.

19. The lamp according to claim 11, wherein the light-emitting component includes a third lens, and the third lens is fixed on the light-emitting component.

20. The lamp according to claim 1, wherein the light emitting component is located inside the lens.
